(19) United States
(12) Patent Application Publication
(10) Pub. No.: US 2019/0276770 A1
(43) Pub. Date: Sep. 12, 2019

(54) REMOVAL OF ORGANIC DEPOSITS

(71) Applicant: Ecolab USA Inc., St. Paul, MN (US)

(72) Inventors: Herman Grondman, Delden (NL); Peter In`t Veld, Delden (NL); Audrey Doron, Delden (NL); Anne Saramito, Delden (NL)

(21) Appl. No.: 16/090,682

(22) PCT Filed: Apr. 4, 2017
(86) PCT No.: PCT/IB2017/051915

§ 371 Date: Oct. 2, 2018

(30) Foreign Application Priority Data
Apr. 4, 2016 (GB) 1605771.3

(51) Int. Cl. C11D 1/34; C11D 3/43; C11D 3/18; C11D 3/04; C11D 7/50

(52) U.S. Cl. CPC C11D 1/345; C11D 3/43; C11D 7/5027; C11D 3/046; C11D 3/18

(57) ABSTRACT

Disclosed is a cleaning composition for removing organic deposits. The cleaning composition comprises a salt of the monoconjugate base of an aliphatic phosphate monoester and a salt of the conjugate base of an aliphatic phosphate diester in a hydrocarbon-based solvent system. The cleaning composition has been found to be effective in use together with an aqueous phase in mobilizing or dissolving organic deposits, without forming persistent emulsions, suspensions or the like. Accordingly following its use phase separation between a hydrocarbon-based phase and an aqueous phase occurs following a settling period.

### FIELD OF THE INVENTION

The invention relates to removal of organic deposits such as paraffinic or asphaltenic deposits, and in particular to removal of such deposits from industrial installations such as fluid flow systems in chemical plants, refineries, supply pipelines and the like.

### BACKGROUND TO THE INVENTION

Industrial installations such as oil and gas production facilities, refineries and petrochemical plants may be prone to build-up of organic deposits, such as paraffinic and asphaltenic deposits, sludges, slop oil, oily vegetable deposits etc.

Maintenance therefore commonly includes the removal of organic deposits from internal surfaces, such as pipes, tanks, valve surfaces etc. Cleaning may be achieved by mechanical or chemical cleaning methods, or a combination of these methods.

Mechanical cleaning includes methods such as pigging of flowlines and manual cleaning of settling and storage tanks. These methods typically require facilities to be shut down, which must be planned in advance and typically co-ordinated with other operations. In addition to the long lead times required, personnel access to confined spaces is potentially hazardous, and large volumes of waste (typically contaminated water) may be produced, resulting in waste disposal problems (e.g. oil-water separation) and associated cost.

Chemical cleaning is therefore often preferred over mechanical cleaning for removal of organic deposits from industrial installations, because cleaning may be conducted more safely, rapidly and at lower cost.

Chemical cleaning frequently involves the usage of aromatic and/or aliphatic hydrocarbon solvents, to dissolve and mobilize organic deposits. It is common in addition to combine organic solvents with aqueous surfactants. This strategy reduces the overall usage of organic solvent (which can be costly and associated with substantial downstream disposal costs) and in some cases can result in improved cleaning efficiency.

Use of such organic/aqueous formulations results in the emulsification of an organic solvent/deposit phase in an aqueous phase. Frequently a major disadvantage of using such formulations is the formation of stable emulsions which are problematic to process in order to separate the oil and water phases.

Accordingly, there remains a need for improvements to the cleaning of industrial installations to address one or more of the problems associated with known approaches.

### SUMMARY OF THE INVENTION

According to a first aspect of the invention there is provided a cleaning composition for removing organic deposits, the cleaning composition comprising;
a salt of the monoconjugate base of an aliphatic phosphate monoester;
a salt of the conjugate base of an aliphatic phosphate diester; and
and a hydrocarbon-based solvent system.

The inventive compositions have been found to be effective in use together with an aqueous phase, in mobilizing or dissolving organic deposits without forming persistent emulsions, suspensions or the like. For example, following the use of the inventive compositions, phase separation between a hydrocarbon-based phase and an aqueous phase may occur following a settling period. The organic and aqueous phases may thus be readily separated and processed or disposed of accordingly.

By a monoconjugate base of an aliphatic phosphate monoester we refer to the species formed following a single deprotonation of the aliphatic phosphate monoester. That is to say, a monoconjugate base of a diprotic acid is the species formed when only one of the acidic hydrogens has been dissociated. Similarly, the conjugate base of the aliphatic phosphate diester is the species formed following the deprotonation of the aliphatic phosphate diester.

The salt of the monoconjugate base of the aliphatic phosphate monoester and the salt of the conjugate base of the aliphatic phosphate diester may be present in approximately equal amounts, including at or around a 1:1 mole ratio.

The ratio of monoester:diester may be in the range of around 1.2:0.8 to around 0.8:1.2. In some embodiments, the ratio of monoester:diester comprises 0.1:0.9, 0.2:0.8, 0.3:0.7, 0.4:0.6, 1:1, 0.6:0.4, 0.7:0.3, 0.8:0.2 or 0.9:0.1.

The molar ratio of the salt of the monoconjugate base of the aliphatic phosphate monoester to the salt of the conjugate base of the aliphatic phosphate diester may range from around 0.01:0.99 to around 0.99 to 0.01; or from around 0.1:0.9 to around 0.9:0.1.

It will be understood that the weight % of each of the said salts will vary dependent on their relative molecular weights. The cleaning composition may comprise a combined weight % of between around 0.05 wt % to around 80 wt %, or around 0.1 wt % to around 80 wt %, or around 0.1 wt % to around 75 wt %, of the said salts. The cleaning composition may comprise a combined weight % of between around 70 wt % and 80 wt % of the said salts.

In some embodiments, the cleaning composition may comprise a combined weight % of between around 5% and 15% of the said salts. The cleaning composition may comprise between around 8% and 15%, or between around 10% and 13%, or between around 10% and 12%, by weight of the said salts. In some embodiments, the cleaning composition comprises around 10.5%, 10.6%, 10.9%, 11.1%, 11.3% or 12.2%, by weight of the said salts.

The balance of the cleaning composition may be made up by the solvent system.

The cleaning composition may comprise one or more further constituents, for example one or more further phosphate mono- or di-ester species.

The cleaning composition may comprise acid species having at least three dissociation constants (Ka); associated with the first deprotonation of the monoester, deprotonation of the diester and the second deprotonation of the monoester. Accordingly, it will be appreciated that amounts of any or all of the available conjugate acid and base species may be present in the cleaning composition.

Accordingly, whereas the monoconjugate base of the aliphatic phosphate monoester and the conjugate base of the aliphatic phosphate diester may be the most abundant phosphate species present, smaller amounts of the respective conjugate acid forms (of both the mono-and di-ester) and the diconjugate base form of the monoester, may also be present. For example, the combined wt % of the said conjugate acid forms and said diconjugate base form may be below around 5 wt %, 1 wt %, 0.5 wt %, 0.1 wt % or 0.01 wt % of the cleaning composition. The amounts of the conjugate acid forms the diconjugate base form may be below around 20%, 10%, 1% or 0.1% of the amount of the corresponding monoconjugate base of the aliphatic phosphate monoester or conjugate base of the aliphatic phosphate diester.

The said conjugate acid forms and/or the said diconjugate base forms may be present only in trace amounts (for example below around, or around 0.01 wt %).

The relative proportions of these conjugate acid/base species may vary depending on overall concentrations, relative concentrations, dilution, pH, ionic concentration, temperature or the like.

The aliphatic phosphate diester may be a diester of a single aliphatic alcohol. The aliphatic phosphate diester may be a diester of two aliphatic alcohols.

The aliphatic phosphate monoester and the aliphatic phosphate diester may esters of the same, or different, aliphatic alcohols.

The aliphatic groups of the monoconjugate base of the aliphatic phosphate monoester and the conjugate base of the aliphatic phosphate diester may, independently, be straight chain or branched.

The aliphatic groups may independently be saturated or unstaturated.

The aliphatic groups may independently be C₃-C₁₂ aliphatic groups, or C₃-C₁₁ or C₃-C₁₀ aliphatic groups. In some embodiments, one or more (or all) of the aliphatic groups may be C₄-C_{12,} or C₄-C₈ aliphatic groups. In some embodiments, C₆-C_{10,} or C₇-C₉ aliphatic groups are preferred.

The salt of the monoconjugate base of the aliphatic phosphate monoester, and/or the salt of the conjugate base of the aliphatic phosphate diester, may be an alkali metal salt, an alkaline earth metal salt, a transition metal salt (including rare earth metals), an ammonium salt, an alkylammonium salt or a hydroxyalkylammonium salt. For example, the cleaning composition may comprise an ammonium, sodium or hydroxyethylamonium salt of said monoconjugate base or said conjugate base.

The cleaning composition may comprise substantially equal amounts of compounds (A) and (B).

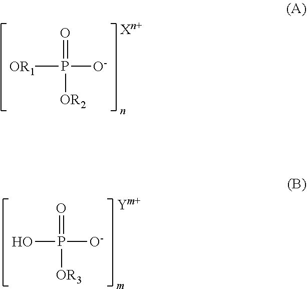

wherein R_{1,} R₂ and R₃ are, independently, straight chain or branched; saturated or unsaturated C₄-C₁₂ aliphatic groups;

n and m are, independently, 1 or 2; and

X and Y are monovalent or divalent cations.

R_{1,} R₂ and R₃ may be independently selected from the group; C₄-C₁₂ alkyl; or from the group C₄-C₈ alkyl; or from the group C₄ alkyl and C₈ alkyl.

R₁ and R₂ may be the same. R₃ may be the same as R₁ and/or R₂.

X and Y may be independently selected from cations of the group; alkali metal, alkaline earth metal, transition metal, rare earth metal, ammonium, alkylammonium, hydroxy-alkylammonium.

X and Y may be independently selected from the group Na³⁰ , NH₄⁺, HO—CH₂—CH₂—NH₃⁺; or from the group Na⁺, NH₄⁺.

X and Y may be the same. X and Y may be NH₄⁺.

As used herein, “hydrocarbon-based solvent system” refers to a solvent system the major component of which consists of at least one hydrocarbon solvent, for example at least around 50%, at least around 60%, at least around 70%, 75%, 80%, 85% or 90% by weight of the solvent system consists of the at least one hydrocarbon solvent.

As used herein, “hydrocarbon solvent” refers to a generally lipophilic or oleophilic solvent (for example paraffinic, aliphatic or aromatic solvent, or a halogenated or perhalogenated solvent).

The hydrocarbon solvent may be polar or non-polar.

The hydrocarbon-based solvent system may comprise a blend of hydrocarbon solvents.

The hydrocarbon solvent(s) may be selected according to the organic deposit to be removed. For example, for the removal of wax or asphaltenic deposits as encountered in oil and gas production, a solvent system comprising a paraffin or paraffin blend, such as kerosene or a naphtha, or a solvent system comprising one or more aromatic solvents, such as a heavy aromatic naphtha-based solvent system may be used.

The cleaning composition may comprise one or more co-solvents; including, but not limited to an organic co-solvent, such as one or more of alcohols (e.g. C₁-C₂₀ branched or straight chain aliphatic alcohols), polyols (e.g. ethylene glycol), or a polyol derivative (e.g. elthylene glycol monobutyl ester). The cleaning composition may comprise water as a co-solvent.

The cleaning composition may comprise two co-solvents. The two co-solvents may be an organic co-solvent, such as elthylene glycol monobutyl ester, and water. The co-solvents may be miscible with one another.

The one or more co-solvents may comprise the balance of the cleaning composition other than the hydrocarbon solvent and the said salts. Accordingly the cleaning composition may comprise between around 0% and 50%, 0% and 40%, 0% and 30%, or 0% and 15%, or 0% and 10% by weight of the one or more co-solvents. In some embodiments, the cleaning composition may comprise between around 1% and 50%, 1% and 40%, 1% and 30%, 1% and 15%, 1% and 10%, 3% and 15%, 3% and 12%, 5% and 50%, 5% and 40%, 5% and 30%, or 5% and 15% by weight of the one or more co-solvents. In another embodiments, the cleaning composition may comprise between around 6% and 12% by weight of the one or more co-solvents.

The cleaning composition may comprise between around 3% and 10% by weight of a first co-solvent, and between around 0% and 5% of a second co-solvent. For example, in some embodiments, the cleaning composition comprises around 5%-8% of an organic co-solvent and around 1%-3% (1%-4% or 1%-5%) of water. The cleaning composition may comprise around 6.5% of an organic co-solvent and around 3% (e.g. 2.9% or 3.4%) by weight of water.

The hydrocarbon-based solvent system may comprise between around 0% and 50%, 0% and 40%, 0% and 30%, 0% and 20%, or 0% and 10% by weight of the one or more co-solvents. The hydrocarbon-based solvent system may comprise between around 1% and 50%, 1% and 40%, 1% and 30%, 1% and 20%, 1% and 10%, 3% and 20%, 3% and 15%, 5% and 50%, 5% and 40%, 5% and 30%, or 5% and 20% by weight of the one or more co-solvents. The hydrocarbon-based solvent system may comprise between around 8% and 14% by weight of the one or more co-solvents.

The hydrocarbon-based solvent system may comprise between around 3% and 12% by weight of a first co-solvent, and between around 0% and 6% of a second co-solvent. For example, in some embodiments, the hydrocarbon-based solvent system comprises around 6%-8% of an organic co-solvent and around 1%-3% (or 1%-4% or 1%-5%) of water. The hydrocarbon-based solvent system may comprise around 7% of an organic co-solvent and around 3%-4% (e.g. 3.2% or 3.8%) by weight of water.

In use, the cleaning composition may be diluted or mixed with an additional component, for example with water or brine.

In a second aspect the invention extends to a cleaning formulation comprising; a cleaning composition according to the first aspect of the invention; and at least an equivalent amount of water.

Depending on the intended use, the ratio, by volume, of composition:water may be at least around 1:1, 1:1.5, 1:2, 1:4, 1:5 or more. In an embodiment, the ratio, by volume, of composition:water may be in the range of 1:10 to 1:3, or 1:9 to 1:4. For example for a batch cleaning process, the composition may be present in an amount of 10-20% by volume in water. Whereas, in continuous flow applications (for example in use to prevent organic depositions in a pipeline, or tank) the composition may be present in an amount of between around 0.01%-2%, or 0.05%-1% by volume, based on other liquids (e.g. oil and/or brine) present.

The cleaning formulation may be homogenous or inhomogeneous. The formulation may be bi-phasic; comprising a hydrocarbon-based phase and an aqueous phase. When agitated, the formulation may form an emulsion, wherein phase separation occurs following a settling period, as described in further detail below.

The cleaning composition may be miscible, or more typically partially miscible or immiscible with water. For example, water may be partially miscible with and thus present at a certain concentration in the hydrocarbon-based solvent system. A component of the hydrocarbon-based solvent system may be partially miscible in the aqueous phase.

One or more of the species present in the cleaning composition (for example the said salts) may be at least partially soluble in both the solvent system and the aqueous phase. One or more of the species present in the cleaning composition may congregate and temporarily stabilise boundaries between the solvent system and aqueous phase.

The degree of solubility/miscibility may vary in accordance with the ambient conditions, and in particular temperature.

The water may be pure water, or may be of an industrial grade (and so comprise low or trace concentrations of one or more impurities, such as inorganic salts). The water may be sea water (i.e. brine).

The pH of the cleaning composition (at 5 wt % of the cleaning composition in water) may be above around 4, or may be above around 4.5. The pH of the cleaning composition (at 5 wt % of the cleaning composition in water) may be around or above 4.8.

In certain preferred embodiments, the pH of the cleaning composition (at 5 wt % of the cleaning composition in water) may be above around 5. The pH of the cleaning composition (at 5 wt % of the cleaning composition in water) may be in the range of around 5.0-6.0, or around 5.4-5.5.

pH may be determined for a stirred mixture of 5 wt % of the composition in deionized water at ambient temperature (20-25° C.), as follows: A pH glass electrode (e.g. LE409-DIN) and a temperature sensor connected to a digital pH meter are immersed in the stirred mixture. When the signal has stabilized the pH value of the mixture is recorded. The pH meter is precalibrated using standard buffer solutions with pH 4.00 and 7.00.

As mentioned above, there are acid/base equilibria associated with the cleaning composition, relating to the first and second deprotonation of the monoester and the deprotonation of the diester. Each of these acid/base equilibria has an equivalence point;

that is to say a basicity at or above which substantially all of the species exist in their deprotonated, conjugate base form (mono- or di-conjugate, as the case may be). An equivalence point may coincide with the addition of a molar equivalent amount of base to an acid, or vice versa.

Most typically, each of the three equivalence points occur at a different basicity. Thus, the cleaning composition may be considered to have an upper, a lower and an intermediate equivalence point.

It may be desirable for the cleaning composition to be at a basicity around or slightly below the intermediate equivalence point.

The inventors have found that a basicity around the intermediate equivalence point may be associated with improved cleaning and settling performance.

The proportions of the conjugate acid and base forms of a given species may be very sensitive to basicity, around or below its equivalence point.

It is proposed that improved cleaning performance of the inventive compositions may be associated with the proportion of the conjugate base species associated with the intermediate equivalence point. In particular, it may be desirable for the composition to be as close to the intermediate equivalence point as possible, so as to minimise the proportion of the relevant conjugate acid form present in the cleaning composition, without exceeding the basicity of intermediate equivalence point.

In some embodiments, for example wherein the aliphatic groups are all the same, the equivalence point of the aliphatic diester may be the intermediate equivalence point. Improved cleaning performance may be associated with reducing or minimizing the proportion of the conjugate acid form of the aliphatic phosphate diester which is present.

An equivalence point may also be referred to as an end point or stoichiometric point.

The basicity of a formulation or composition may be characterised by its pH, or measured pH (which may differ from actual pH depending on the particular solvent-system or degree of dilution of the cleaning composition). The basicity of a composition may correspond to the amount of a basic species which is present or has been added thereto.

In third aspect of the invention there is provided a method of removing organic deposits from an article, comprising;

providing a cleaning composition comprising;
a salt of the monoconjugate base of an aliphatic phosphate monoester; and
a salt of the conjugate base of an aliphatic phosphate diester; and
a hydrocarbon-based solvent system;

and applying the cleaning composition to an article comprising an organic deposit.

The said salts may be provided in approximately equimolar amounts.

The method may comprise dissolving at least a portion of the organic deposit.

The method may comprise forming a solution of the dissolved organic deposit in the hydrocarbon-based solvent system.

One or more portions or components of the organic deposit may be otherwise mobilized. For example, the organic deposit may comprise substantially insoluble organic components such as heavy crude fractions, or inorganic particulates such as sand. These may be mobilized in use of the composition, for example brought into suspension or carried in a fluid flow.

The method may comprise applying the cleaning composition and water to an article comprising an organic deposit.

The method may comprise applying the cleaning composition to an article and subsequently applying water to the article.

The method may comprise adding amounts of the cleaning composition and water together.

The method may comprise adding at least an equivalent amount of water to the cleaning composition (or vice versa); for example to form a cleaning formulation as described herein.

The method may comprise separating an aqueous phase and a hydrocarbon-based phase, after application of the cleaning composition (and optionally additionally water) to the article.

The hydrocarbon-based phase may comprise said dissolved organic deposit.

The hydrocarbon-based phase may comprise the water-immiscible hydrocarbons, including at least those of the hydrocarbon-based solvent system. The hydrocarbon-based phase may differ from the hydrocarbon-based solvent system, in the amount of water or water-miscible co-solvent present.

The phases may be separated by allowing a settling period to elapse. Phase separation may be facilitated by use of a phase separation apparatus, such as a parallel plate separator, or by contacting the phases with a separation medium such as a mesh, or by centrifuging.

Advantageously, the phases may be separated without the addition of further chemicals. The settling period may be hours or days. For example, the settling period may be between around 1-1000 hours, 1-500 hours or 1-100 hours. The settling period may be around 1-4 days, or around 2 days. The settling period may be of the order of weeks, for example 1-4 weeks.

The composition may be a composition in accordance with the first aspect. The composition may be obtained or obtainable by way of the methods of other aspects detailed herein.

The method may comprise diluting the composition. The composition may be diluted with water (including for example industrial grade water or brine).

The method may comprise adding together an amount of the composition and an amount of water. The method may comprise adding water to the composition, or vice versa.

The method may comprise providing a cleaning formulation comprising a said composition and at least an equivalent amount of water.

Depending on the intended use, the ratio, by volume, of composition:water may be around 2:1, 1.5:1, 1:1, 1:1.5, 1:2, 1:4, 1:5, 1:6, 1:7, 1:8, 1:10, 1:15, 1:30, 1:50 or 1:100. The ratio, by volume, of composition:water may be between around 1:1 and 1:100, or between around 1:5 and 1:50, or 1:10 and 1:30. The method may comprise providing a cleaning formulation in accordance with the second aspect.

The method may comprise mixing the water and the composition.

The composition, or one or more components thereof, may be immiscible, partly miscible or miscible with water and thus mixing the composition with water may comprise diluting the composition, or may result in the formation of a biphasic system.

The composition and water may be added together at any stage. The composition and water may be added together prior to application to an article. For example, a cleaning formulation may be pre-prepared and applied to an article (e.g. introduced into a fluid flow system such as a pipeline, refinery, or the like). The composition and water may be added together in situ For example, a composition may be applied to an article and water subsequently added.

The composition and water may be added together in a single step, or in several steps.

The article may be a surface. The surface may be an internal surface, for example of a conduit or valve in a fluid flow system, or a tank such as a storage tank.

The surface may be an external surface.

The article may be pipework, a valve, a filter medium or the like. The article may form part of an industrial installation, such as a fluid flow system e.g. an oil/gas refinery or production facility, chemical plant, a brewery, distillery or the like.

The article may comprise a textile (for example a woven filter medium, or clothing).

The organic deposit may be a wax, paraffinic, or heavy asphaltenic deposit, as encountered for example in production and refining of crude oil. The organic deposit may be a waste material such as oil-based waste generated in recycling facilities. The organic deposit may comprise plant matter, such as vegetable oil(s). The organic deposit may comprise a range of constituents.

This invention relates to the cleaning and removal of organic deposits such as paraffinic and asphaltenic deposits, sludges, slop oil, schmoo, chemical waste from the inside of industrial installations such as oil and gas production facilities, refineries and petrochemical plants and using surface active, phosphate ester based compositions. In addition, these compositions may be used for cleaning of exterior surfaces of industrial installations by removing organic deposits such as dirt, crude oil and grease deposits from oil and gas production platforms (rig wash), cargo tanks, tank decks, etc.

In fourth aspect of the invention there is provided a method of preventing or mitigating the build-up of organic deposits, comprising;

providing a cleaning composition comprising;
a salt of the monoconjugate base of an aliphatic phosphate monoester; and
a salt of the conjugate base of an aliphatic phosphate diester; and
a hydrocarbon-based solvent system; and mixing the cleaning composition with fluid flowing through a fluid flow system.

The method may for example comprise introducing a flow of the cleaning composition into a fluid flow system (to thereafter become mixed with the fluids flowing therein).

The method may comprise mixing the cleaning composition in an amount of between around 0.01%-2%, or 0.05%-1% by volume, of the fluid flowing through the fluid flow system.

The method may comprise flowing the mixture through at least a part of a fluid flow system. The method may comprise separating an aqueous phase and a hydrocarbon-based phase, after mixing of the cleaning composition and the fluid flowing through the fluid flow system. For example, the phases may be separated by allowing for a settling period, for example within a settling tank, forming part of the fluid flow system.

The fluid flow system may for example be an oil pipeline (for a refined oil fraction or crude oil), or a chemical plant may comprise the fluid flow system (e.g. an oil production or refining facility).

According to a fifth aspect of the invention there is provided a method of preparing a cleaning composition for removing organic deposits, the method comprising;
providing a first solution comprising an aliphatic phosphate monoester and an aliphatic phosphate diester;
adding a base to the first solution in an amount sufficient to increase the basicity of the solution to around or to just below the intermediate equivalence point;
   thereby forming a second solution comprising a salt of the monoconjugate base of the aliphatic phosphate monoester; and a salt of the conjugate base of the aliphatic phosphate diester;
adding a hydrocarbon solvent to the second solution, to thereby form the cleaning composition.

The equivalence point may be determined empirically; for example by titration of an amount of the first solution against the base.

The equivalence point may be calculated, based on a known composition of the first solution.

When we refer to the basicity of the solution being at or around the intermediate equivalence point, we include adding an amount of base in a molar amount substantially equal to the combined molar amounts of the aliphatic phosphate mono- and diesters.

In increasing the basicity to just below the intermediate equivalence point, a molar amount of a base may have been added of at least around 75%, 80%, 85%, 95% or 98% of the combined molar amounts of the aliphatic phosphate mono- and diesters.

The equivalence point may also be viewed from the perspective of the proportion of the relevant conjugate acid present in the second solution (most typically of the aliphatic phosphate diester). The second solution may comprise less than 30%, 20%, 10%, 5% or 2% of the aliphatic phosphate diester in its conjugate acid form. Around the intermediate equivalence point, only trace amounts may be present.

The base may be added to the first solution in the form of a basic solution. For example an amount of a basic solution (e.g. an aqueous solution of a base such as a hydroxide salt).

The base may be added to the first solution in the form of a solid, such as a salt which is soluble in the first solution.

The base may be in added to the first solution in the form of a compound, such as an amine (such as an alkylamine or a hydroxy-alkylamine) or ammonia, which is soluble in, miscible with or reacts in, the first solution, to increase its basicity.

In particular embodiments, the base may be added as ammonia gas. For example, ammonia gas may be bubbled through the first solution, optionally under stirring, to form the second solution.

Direct addition of a base in this way gives rise to a second solution which is in effect a “concentrate” suitable, having a higher aliphatic phosphate mono/di-ester concentration than has previously been possible, to be made up into a cleaning composition or formulation as described herein. Indeed for some applications, the concentrate may be applied directly to an article.

Accordingly, the invention extends in a sixth aspect to a method of making a concentrate for a cleaning composition, comprising;
providing a first solution comprising an aliphatic phosphate monoester and an aliphatic phosphate diester;
adding a base to the first solution in an amount sufficient to increase the basicity of the solution to at or just below the intermediate equivalence point;
   thereby forming the concentrate.

The first solution may be an aqueous solution. The first solution may comprise a solvent blend. For example, the first solution may comprise a solvent blend of an organic co-solvent and water.

The second solution may be based on the same solvent blend at the first solution (for example the base may be dissolved in the same solvent blend, or may be added without additional solvent). The second solution may comprise a still further co-solvent, for example where the base provided in solution in a further solvent, such as an alcohol or polyol. The second solution may be based on a different blend of the co-solvents present in the first solution, for example where an aqueous solution of a base is added.

The method may comprise adding more than one hydrocarbon solvent, together or sequentially. The method may comprise adding a hydrocarbon solvent blend to the second solution. Thus, following addition of the hydrocarbon solvent, the cleaning composition comprises a hydrocarbon-based solvent system.

One or more components of the second solution (for example the solvent or co-solvent(s)) may be immiscible or partially miscible in the hydrocarbon solvent or hydrocarbon solvent blend. Thus, the resulting composition may be homogeneous or biphasic.

A biphasic cleaning composition may be capable of forming an emulsion. The emulsion may be an unstable emulsion (for example persisting for a few minutes, hours or days—before separation of a hydrocarbon-based phase).

The method may comprise mixing or otherwise agitating the cleaning composition so as to form an emulsion.

The hydrocarbon solvent (or solvent system) may be added in mass ratio of at least around 1:1, 2:1, 4:1 or 5:1 in relation to the second solution.

The hydrocarbon solvent (or solvent system) may be added in mass ratio of between around 1:1 and 10:1, or between around 1:1 and 8:1, or 1:1 and 5:1, or 2:1 and 10:1, or 2:1 and 8:1, or 4:1 and 8:1; in relation to the second solution.

The method may comprise adding the cleaning composition and water together, to form a cleaning formulation. The cleaning composition may be added together with at least an equivalent amount of water.

The water may be added in a mass ratio of at least around 2:1, 1.5:1, 1:1, 1.5:1, 2:1, 4:1 1:5, 1:6, 1:7, 1:8, 1:10, 1:15, 1:30, 1:50 or 1:100, in relation to the cleaning composition. The water may be added in a mass ration of between around 1:1 and 1:100, or between around 1:5 and 1:50, or 1:10 and 1:30, in relation to the cleaning composition.

One or more components of the cleaning composition may be immiscible or partially miscible with water. Thus, the resulting cleaning formulation may be homogeneous or biphasic.

A biphasic cleaning formulation may be capable of forming an unstable emulsion (for example persisting for a few minutes, hours or days—before separation of an aqueous phase and a hydrocarbon-based phase).

The method may comprise mixing or otherwise agitating the cleaning formulation (e.g. during addition) so as to form an unstable emulsion.

In a seventh aspect, the invention extends to a cleaning composition or a cleaning formulation obtained or obtainable by the method of the fifth aspect. In an eighth aspect, there is provided a concentrate for a cleaning composition, obtained or obtainable by the method of the sixth aspect.

It will be understood that alternative, preferred and optional features disclosed in relation to a particular aspect of the invention, also correspond to alternative, preferred or optional features of any other aspect of the invention herein disclosed.

### BRIEF DESCRIPTION OF THE DRAWINGS

Non-limiting example embodiments will now be described with reference to the following figures in which:

FIG. 1 shows tabulated results for Test A conducted on examples 1-18 (see Table 1 below), in which the wt % of wax ball dissolution is plotted, together with the relative proportions of oil and water phases observed.

FIG. 2 shows photographs of sample bottles following Test B conducted on examples 1-18 (see Table 1 below).

### DETAILED DESCRIPTION OF EXAMPLE EMBODIMENTS

Phosphate esters were obtained by reacting appropriate alcohols with phosphorus pentoxide (in a 3:1 molar ratio) to give an approximately equimolar mixture of the corresponding alkyl mono- and di-alkyl esters of phosphoric acid.

This mixture was used as such to prepare a mixture of salts. Salts of such alkyl phosphate mono- and di-esters were produced by reacting with either ammonia, sodium hydroxide, or monoethanolamine in a mixture of solvents using conventional methods.

Details of example cleaning compositions 1-18 are presented in Table 1.

TABLE 1

| | 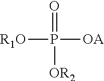 | | | | | | | |
|---|---|---|---|---|---|---|---|---|
| | Phosphate esters (PEs) | | | Component (wt-%) | | | | |
| | | | | | | | Ehtylene | |
| | | | | | | Heavy | glycol | |
| | | | | | | aromatic | monobutyl | |
| | A | R1 | R2 | PEs | Kerosene | naphtha | ether | Water |
| 1 | NH₄ | 2-Ethylhexyl | R1 and H, ratio 1/1 | 10.6 | 80.0 | 0 | 6.5 | 2.9 |
| 2 | Na | 2-Ethylhexyl | R1 and H, ratio 1/1 | 10.8 | 79.3 | 0 | 6.5 | 3.4 |
| 3 | H₃NC₂H₄OH | 2-Ethylhexyl | R1 and H, ratio 1/1 | 12.2 | 80.0 | 0 | 6.5 | 1.3 |
| 4 | NH₄ | iso-Tridecyl | R1 and H, ratio 1/1 | 10.5 | 80.6 | 0 | 6.5 | 2.4 |
| 5 | Na | iso-Tridecyl | R1 and H, ratio 1/1 | 10.6 | 80.0 | 0 | 6.5 | 2.9 |
| 6 | H₃NC₂H₄OH | iso-Tridecyl | R1 and H, ratio 1/1 | 11.6 | 80.0 | 0 | 6.5 | 1.9 |
| 7 | NH₄ | n-Butyl | R1 and H, ratio 1/1 | 10.9 | 79.2 | 0 | 6.5 | 3.4 |
| 8 | Na | n-Butyl | R1 and H, ratio 1/1 | 11.1 | 77.5 | 0 | 6.5 | 4.9 |
| 9 | H₃NC₂H₄OH | n-Butyl | R1 and H, ratio 1/1 | 13.2 | 80.0 | 0 | 6.5 | 0.3 |
| 10 | NH₄ | 2-Ethylhexyl | R1 and H, ratio 1/1 | 10.6 | 0 | 80 | 6.5 | 2.9 |
| 11 | NH₄ | 2-Ethylhexyl | R1 and H, ratio 1/1 | 10.6 | 0 | 0 | 86.5 | 2.9 |
| 12 | NH₄ | 2-Ethylhexyl | R1 and H, ratio 1/1 | 10.6 | 0 | 0 | 6.5 | 82.9 |
| 13 | NH₄ | 2-Ethylhexyl | R1 and NH4, ratio 1/1 | 10.9 | 80.0 | 0 | 6.5 | 2.6 |
| 14 | Na | 2-Ethylhexyl | R1 and Na, ratio 1/1 | 11.3 | 76.8 | 0 | 6.5 | 5.4 |
| 15 | NH₄ | iso-Tridecyl | R1 and NH4, ratio 1/1 | 10.6 | 80.0 | 0 | 6.5 | 2.9 |
| 16 | Na | iso-Tridecyl | R1 and Na, ratio 1/1 | 10.9 | 79.0 | 0 | 6.5 | 3.6 |
| 17 | NH₄ | n-Butyl | R1 and NH4, ratio 1/1 | 11.4 | 79.2 | 0 | 6.5 | 2.9 |
| 18 | Na | n-Butyl | R1 and Na, ratio 1/1 | 11.8 | 76.9 | 0 | 6.5 | 4.8 |

Examples 1-18 were evaluated for cleaning efficiency (Test A) and emulsion forming tendency (Test B) as follows.

Test A: Wax Ball Dissolution Test

An amount of 2.50 grams of a waxy deposit isolated from a crude oil production facility was shaped into a ball. The ball was placed in a 100 ml bottle and 40 ml of tap water and 10 ml of an example product formulation (Table 1) was added. The bottle was closed and shaken one time by hand, whereafter the wax ball was located at the oil-water interface. The bottle was stored for 48 hours at 20° C.

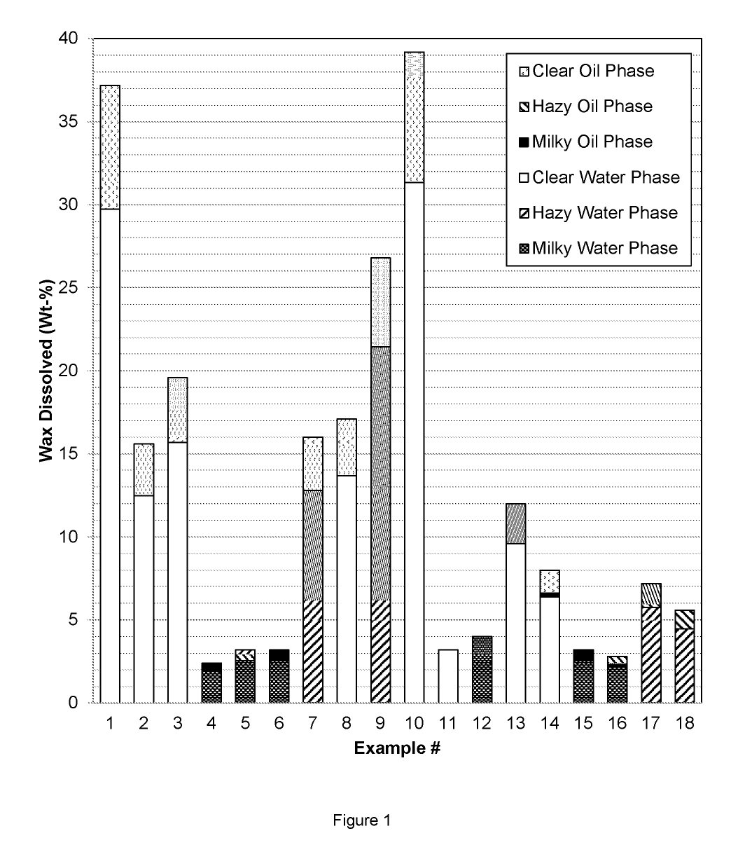

Following the storage period, the appearance of the liquid(s) was recorded. Results are summarised in Table 2 and FIG. 1.

Each sample was assessed for the presence of separate a separate hydrocarbon-based phase (“Oil phase”, table 2) and an aqueous phase (“Water phase”, table 2). In addition, each phase was assessed for turbidity; i.e. whether clear, hazy (i.e. partially clear) or milky.

In addition, following separation (by decanting) of the liquid portion, the undissolved remainder of the wax ball dried for 3 hours at 95° C. on a petri dish.

The weight of the dried wax was then determined, and the weight percentage of dissolution of the wax ball was calculated as follows: wt %=(remaining weight (g)/2.50)×100%. Results are presented in Table 2 and FIG. 1.

TABLE 2

| | Wax | | |
|---|---|---|---|
| Example | dissolved | Appearance liquids 48 h | |
| # | (Wt %) | Oil phase | Water phase |
| 1 | 37.2 | Clear | Clear |
| 2 | 15.6 | Clear | Clear |
| 3 | 19.6 | Clear | Clear |
| 4 | 2.4 | Milky | Milky |
| 5 | 3.2 | Hazy | Milky |
| 6 | 3.2 | Milky | Milky |
| 7 | 16.0 | Clear | Hazy |
| 8 | 17.1 | Clear | Clear |
| 9 | 26.8 | Clear | Hazy |
| 10 | 39.2 | Clear | Clear |
| 11 | 3.2 | One phase = clear | |
| 12 | 4.0 | One phase = Milky | |
| 13 | 12.0 | Hazy | Clear |
| 14 | 8.0 | Clear | Clear |
| 15 | 3.2 | Milky | Milky |
| 16 | 2.8 | Hazy | Milky |
| 17 | 7.2 | Hazy | Hazy |
| 18 | 5.6 | Hazy | Hazy |

Example B: Removal of Crude Oil

An amount of 10.0 grams of crude oil sample with 20° API gravity were weighed into each of 9 100 ml bottles at 20° C.

Each bottle was capped and shaken by hand to in order to completely coat the inside of the bottle with crude oil. Each bottle was then immediately opened and inverted to allow the crude oil to drain for 10 minutes.

10 gram of each of examples 1-9 (see Table 1) was added to the bottles. The bottles were capped and shaken by hand, opened and inverted to allow the contents to drain for 10 minutes.

Once drained, 15 grams of tap water was add to each of the bottles. The bottles were again capped and shaken by hand, opened and inverted and allowed to drain.

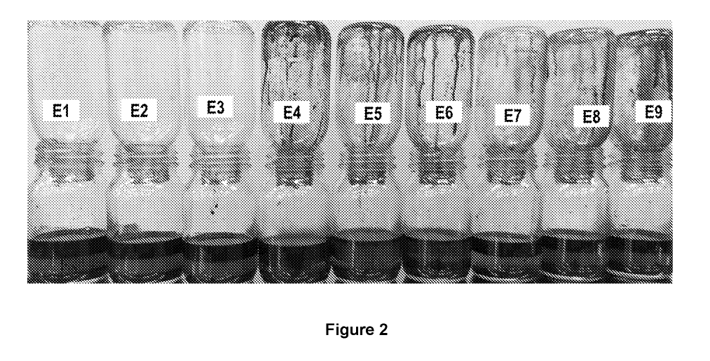

The appearance of the inside of the bottles was photographically recorded as presented in FIG. 2. The appearance of the water phase after 24 hours was visually recorded and is presented in Table 3.

TABLE 3

| Example # | Appearance water phase 24 h |
|---|---|
| 1 | Clear |
| 2 | Clear |
| 3 | Clear |
| 4 | Milky |
| 5 | Milky |
| 6 | Milky |
| 7 | Hazy |
| 8 | Clear |
| 9 | Hazy |

Discussion

Results of Test A (Table 2 and FIG. 1)

Examples 1-3, 8, 10 and 14 resulted in clearly separated oil and water phases.

Examples 1-3, 7-10, 13-14 and 17-18 resulted in significant dissolution of the wax ball; above around 5 wt %

The largest amount of wax dissolved and lowest emulsion forming tendency, as indicated by clear oil and water phases obtained, was observed for Examples 1-3 and 10 with A=NH₄, Na and H₃NCH₂CH₂OH, R₁=2-ethylhexyl, and R₂=2-ethylhexyl/H (1/1).

The largest amount of wax was dissolved for Examples 1 and 10 with A=NH_{4,} R₁=2-ethylhexyl, and R₂=2-ethylhexyl/H (1/1).

Comparatively low percentages of the wax ball was dissolved by examples 4-6 and 15-16; each of which were based on salts of C13 aliphatic (iso-tridecyl) phosphate mono- and di-esters.

Example 11 was based on an organic solvent system (the major solvent being ethylene glycol monobutyl ether, with around 3 wt % water as co-solvent). Example 12 was based on an aqueous solvent system (water with around 6 wt % ethylene glycol monobutyl ether). Neither of these examples 11-12 comprised a hydrocarbon-based solvent system. Examples 11 and 12 also resulted in low percentage wax ball dissolution, in test A.

Results Example B (Table 3 and FIG. 2)

The results obtained for Examples 1-3 clearly demonstrate that best cleaning efficiency combined with lowest emulsion forming tendency, as indicated by clear water phase obtained, was observed for Example 1-3 with A=NH₄, Na and H₃NCH₂CH₂OH, R₁=2-ethylhexyl, and R₂=2-ethylhexyl/H (1/1).

It is noted that for the lighter crude samples (as compared to the wall ball samples of test A) good results are also obtained for example 7, comprising salts of n-butyl phosphate mono-and di-esters.

Basicity

The compositions of Examples 1-8 have a pH (measured at 5 wt % in water) of approximately 5-6, and have each been neutralized to their intermediate equivalence points (as determined by standard titration methods).

The compositions of Examples 13-18 have a pH (measured at 5 wt % in water) of approximately 7 and have been neutralized to around the upper equivalence point.

In Table 2 (and FIG. 1) the performance of the compositions at their intermediate equivalence point can be compared against the corresponding compositions neutralized to the upper equivalence point.

Specifically, by comparing Example 1 vs. Example13, Example 2 vs. Example 14, Example 7 vs. Example 17 and Example 8 vs. Example 18 shows that the best performance is obtained for Examples 1, 2, 7 and 8, all of which have been neutralized to the intermediate equivalence point. Whereas, equivalent compositions 13, 14, 17 and 18 which have a higher basicity (upper equivalence points) have markedly worse performance.

Examples 4, 5, 15 and 16 demonstrate poor performance regardless of basicity.

Example 19. Procedure for the preparation of the concentrated formulation for Example 1 from ammonia gas

In a 500 ml glass reactor equipped with a stirrer and gas inlet tube 211.5 gram of 2-ethylhexyl phosphate ester (monoester: diester mole ratio=1:1), 46.5 gram of ethylene glycol monobutyl ether and 28.5 gram of deionized water where brought together. To this stirred mixture 13.5 gram of ammonia gas was bubbled in through the gas inlet tube which was positioned below the liquid level of the stirred mixture. The ammonia gas was introduced over a period of 2 hours while maintaining a temperature of 20 to 30° C. by external cooling. The product was a clear liquid with a pH of 4.8 (measured as a 5 wt % solution in deionized water).

Example 20: Preparation of the composition of Example 1 from Example 19

To 14.2 gram of product from Example 19 was added 80.0 gram of kerosene, 4.3 gram of ethylene glycol monobutyl ether and 1.5 gram of deionized water. The components were mixed well to give the composition of Example 1 as a clear liquid with a pH of 5.5 (measured as a 5 wt % solution in deionized water).

1.-49. (canceled)

50. A cleaning composition for removing organic deposits, the cleaning composition comprising
a first salt that is a salt of a conjugate base of an aliphatic phosphate diester;
a second salt that is a salt of a monoconjugate base of an aliphatic phosphate monoester; and
a hydrocarbon-based solvent system.

51. The cleaning composition of claim 50 wherein the first and second salts are present in approximately equimolar amounts.

52. The cleaning composition of claim 50 wherein the cleaning composition comprises about 0.1 weight % to 80 weight % of the combined first and second salts.

53. The cleaning composition of claim 50 wherein the first salt and/or the second salt comprises an alkali metal salt, an ammonium salt, an alkylammonium salt or a hydroxyalkylammonium salt.

54. The cleaning composition of claim 50 wherein the first salt has structure (A) and the second salt has structure (B), 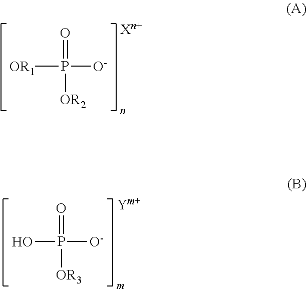
wherein R₁, R₂ and R₃ are independently C₄-C₁₂ aliphatic groups;
n and m are independently 1 or 2; and
X and Y are independently monovalent or divalent cations.

55. The cleaning composition of claim 54, wherein X and Y are independently selected from Na⁺, NH₄⁺, and HO—CH₂—CH₂—NH₃⁺.

56. A cleaning formulation comprising the cleaning composition of claim 50 and water, wherein the ratio by volume of the cleaning composition to the water is between 1:1 and 1:5.

57. A method of removing organic deposits from an article, comprising
providing a cleaning composition, the composition comprising
a first salt that is the salt of the conjugate base of an aliphatic phosphate diester, and
a second salt that is the salt of the monoconjugate base of an aliphatic phosphate monoester,
a hydrocarbon-based solvent system; and
applying the cleaning composition to an article comprising an organic deposit.

58. The method of claim 57, further comprising applying water to the article.

59. The method of claim 58, comprising applying the cleaning composition to the article before applying the water to the article.

60. The method of claim 58, comprising combining the cleaning composition and the water and applying the combination to the article.

61. The method of claim 58 further comprising separating an aqueous phase and a hydrocarbon-based phase after applying the cleaning composition to the article.

62. The method of claim 61 wherein the separating comprises allowing a settling period of 1 to 1000 hours.

63. The method of claim 57 wherein the applying is mixing the cleaning composition with a fluid flowing through a fluid flow system.

64. The method of claim 63 wherein the mixing is mixing about 0.01% to 2% of the cleaning composition by volume of the fluid flowing through the fluid flow system.

65. The method of claim 63 further comprising separating an aqueous phase and a hydrocarbon-based phase after the mixing.

66. A method of preparing a cleaning composition, the method comprising:
providing a first solution comprising an aliphatic phosphate monoester and an aliphatic phosphate diester;
adding a base to the first solution in an amount sufficient to form a second solution comprising a salt of the monoconjugate base of the aliphatic phosphate monoester; and a salt of the conjugate base of the aliphatic phosphate diester; and
adding at least one hydrocarbon solvent to the second solution to form the cleaning composition.

67. The method of claim 66 wherein the base is a basic solution.

68. The method of claim 66 wherein the base comprises ammonia.

69. The method of claim 57 further comprising adding water to the cleaning composition to form a cleaning formulation.
